(19) United States
(12) Patent Application Publication
(10) Pub. No.: US 2025/0052498 A1
(43) Pub. Date: Feb. 13, 2025

(54) GRAPHITIZATION FURNACE

(71) Applicants: ZHENGZHOU NON-FERROUS METALS RESEARCH INSTITUTE CO.LTD OF CHALCO, Zhengzhou (CN); MILUO XINGAO HIGH TECHNOLOGY SERVICE CO., LTD, Yueyang (CN)

(72) Inventors: KaiBin CHEN, Beijing (CN); YingHe LI, Yueyang (CN); JianJun LIU, Beijing (CN); ZhongSheng LUO, Beijing (CN); ChangChun ZHOU, Yueyang (CN); Xun WANG, Beijing (CN); Fu FU, Yueyang (CN); LiZhen SUN, Beijing (CN); Dawei YIN, Beijing (CN); YuJie WANG, Beijing (CN); TingTing DU, Beijing (CN); MengQian CUI, Beijing (CN)

(73) Assignees: ZHENGZHOU NON-FERROUS METALS RESEARCH INSTITUTE CO.LTD OF CHALCO, Zhengzhou, HE (CN); MILUO XINGAO HIGH TECHNOLOGY SERVICE CO., LTD, Yueyang, HU (CN)

(21) Appl. No.: 18/691,821

(22) PCT Filed: Mar. 10, 2023
(86) PCT No.: PCT/CN2023/080670

§ 371 Date: Mar. 13, 2024

(30) Foreign Application Priority Data
Mar. 11, 2022 (CN) 202210241349.9

(51) Int. Cl. F27D 1/00; F27D 1/04; F27D 11/02

(52) U.S. Cl. CPC F27D 1/0036; F27D 1/04; F27D 11/02

(57) ABSTRACT

A graphitization furnace includes a furnace body, an upper lining, an insulating lining, a lower lining, a positive electrode and a negative electrode. The upper lining, the insulating lining and the lower lining are all disposed as attached to an inner wall of the furnace body, and the upper lining, the insulating lining and the lower lining sequentially abut against one another along a direction from top to bottom, and the upper lining, the insulating lining and the lower lining are all substantially provided with first through holes with a common axis. The positive electrode is substantially disposed vertically, a lower end of the positive electrode is disposed within the upper lining, the negative electrode is substantially disposed horizontally, and a middle part of the negative electrode is provided with a second through hole for passing raw ingredients.

### CROSS-REFERENCE TO RELATED APPLICATION

This application claims the priority of Chinese patent application No. 202210241349.9, entitled “Graphitization Furnace” and filed on Mar. 11, 2022, which is incorporated herein by reference in its entirety.

### TECHNICAL FIELD

The present disclosure belongs to a technical field of graphitization furnaces, and in particular relates to a graphitization furnace.

### BACKGROUND

Graphitization furnace refers to the equipment in which non-graphitic carbon materials with stacking structure of hexagonal carbon atom planar network layers are high-temperature treated at a temperature above 2000° C., and the non-graphitic carbon materials are transformed into graphite carbon materials with a three-dimensional regular and ordered structure of graphite by changing physical conditions. At present, among graphitization technologies at home and abroad, only the electric heating technology can be used to realize a transformation into the three-dimensional regular and ordered structure of graphite. Generally, the electric resistance heating technology is used, and Acheson graphitization furnaces, Inner series graphitization furnaces, and Vertical graphitization furnaces have been industrially applied among resistance heating furnaces.

The vertical graphitization furnace is provided with a positive electrode at an upper portion of the furnace body and a negative electrode at a lower portion of the furnace body. During a power-on process, a high-temperature zone is formed between the positive electrode and the negative electrode, so that granular raw ingredients between the positive electrode and the negative electrode are kept at a high temperature and are kept for a period of time, and thus the raw ingredients can be graphitized. With this kind of graphitization furnace, thermal energy utilization rate is high, energy-saving effect is remarkable and product purity is high, however it is very easy to occur short-circuit between the positive electrode and the negative electrode, and there is a great potential safety hazard.

### SUMMARY

In order to solve the above technical problems, a graphitization furnace is provided, which can cause a graphitization process to be stabilized and a potential safety hazard of a possible short circuit between a positive electrode and a negative electrode to be eliminated.

The present disclosure provides a graphitization furnace, which includes a furnace body; an upper lining, an insulating lining, and a lower lining, the upper lining, the insulating lining, and the lower lining being all disposed and attached to an inner wall of the furnace body, the upper lining, the insulating lining, and the lower lining abutting against one another along a direction from top to bottom, and the upper lining, the insulating lining, and the lower lining being all annular; and a positive electrode and a negative electrode, the positive electrode being disposed vertically, a lower end of the positive electrode being disposed within the upper lining, the negative electrode being disposed horizontally, a middle part of the negative electrode being provided with a through hole for passing raw ingredients, and the negative electrode being disposed inside the lower lining.

### BRIEF DESCRIPTION OF DRAWINGS

FIG. 1 is a schematic structural diagram of a graphitization furnace according to some embodiments of the present disclosure;

FIG. 2 is a schematic structural view of an upper lining in FIG. 1 which is deployed; and

FIG. 3 is a schematic diagram of the upper lining in FIG. 2 which is eroded.

Illustration of reference numbers: 1—furnace body, 2—upper lining, 201—first refractory brick, 202—second refractory brick, 203—concave, 3—insulating lining, 4—lower lining, 5—positive electrode, 6—negative electrode, 7—supporting rod.

### DESCRIPTION OF EMBODIMENTS

In order to enable those skilled in the technical field to which the application belongs to understand the application more clearly, the technical solutions of the application will be described in detail below through specific embodiments in conjunction with the accompanying drawings.

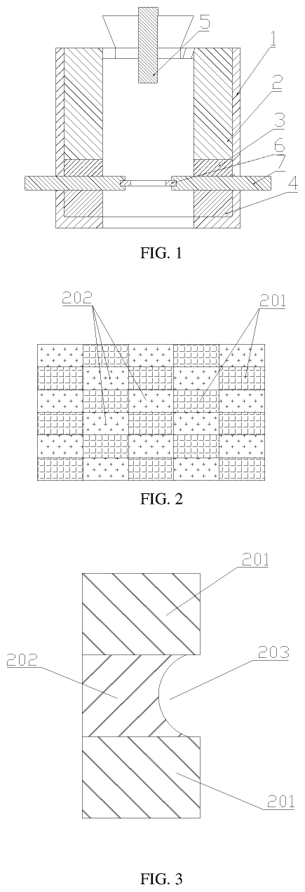

FIG. 1 is a schematic structural diagram of a graphitization furnace according to some embodiments of the present disclosure. Referring to FIG. 1, a graphitization furnace according to the embodiments of the present disclosure may include a furnace body 1, an upper lining 2, an insulating lining 3, a lower lining 4, a positive electrode 5 and a negative electrode 6.

In some embodiments, the upper lining 2, the insulating lining 3 and the lower lining 4 may all be disposed and attached to an inner wall of the furnace body 1. The upper lining 2, the insulating lining 3 and the lower lining 4 may sequentially abut against one another along a direction from top to bottom, and the upper lining 2, the insulating lining 3 and the lower lining 4 may all be provided with first through holes with a common axis. The positive electrode 5 may be disposed substantially vertically, and a lower end of the positive electrode 5 may be disposed within the upper lining 2. The negative electrode 6 may be disposed substantially horizontally. A middle part of the negative electrode 6 may be provided with a second through hole for passing raw ingredients, and the second through hole may be substantially coaxially disposed with the first through holes. The negative electrode 6 may be disposed within the lower lining 4. In some embodiments, a middle section of the negative electrode 6 may be disposed inside the lower lining 4, and two ends of the negative electrode 6 are embedded in or pass through a sidewall of the lower lining 4.

In a graphitization furnace known to the applicant, there is a current flowing among the positive electrode 5, the raw ingredients and the negative electrode 6 for generating heat to perform high-temperature treatment and graphitization on the raw ingredients. Since the linings of the graphitization furnace are made of carbonaceous materials in order to improve corrosion resistance. During a process of the high-temperature treatment, the lining of the graphitization furnace is also graphitized, so that the lining also becomes a conductor, which results in a pathway to be formed among the positive electrode 5, the lining and the negative electrode 6. However, no current passes through the raw ingredients due to high resistance of the raw ingredients, thus a short circuit is caused to be formed between the positive electrode 5 and the negative electrode 6, resulting in a safety accident and a production for graphitization of the raw ingredients is affected. In some embodiments of the present disclosure, an insulating lining 3 may be disposed between the upper lining 2 and the lower lining 4. Even if the upper lining 2 and the lower lining 4 are graphitized during the process of high-temperature treatment, the upper lining 2 and the lower lining 4 are in a state of open circuit due to the disposed insulating lining 3, such that the current can be ensured to smoothly pass among the positive electrode 5, the raw ingredients and the negative electrode 6 to carry out the graphitization process, and therefore electric energy is saved and the graphitization process is stabilized. With the embodiments realized by the present disclosure, the hidden danger of explosion caused by the short circuit between the positive electrode 5 and the negative electrode 6 can be eliminated, thus a direction of the current can be effectively guided, energy can be concentrated, the formation of artificial electric field segments can be promoted, and temperature and product quality of the graphitization furnace can be improved.

In some embodiments, in order to ensure the strength of the insulating lining 3, a thickness of the insulating lining 3 may be 30 mm to 200 mm. If the thickness of the insulating lining 3 is too small, it is easy to be eroded, ablated or oxidized, therefore the insulation can not be achieved due to occurrence of direct connection. If the thickness of the insulating lining 3 is too large, high-temperature resistance performance of the insulating lining 3 is poor. Therefore, it is easy to be softened, and the strength is low and the collapse of a furnace will be caused.

In some embodiments, the insulating lining 3 may be cast from a refractory material, and the refractory material may include one or more of the following: high alumina bricks, zirconia bricks, corundum bricks and clay bricks. Main components of these refractory materials include alumina, zirconia, etc., which have good insulation effect and certain corrosion resistance. Since a position of the insulating lining 3 is close to a bottom portion of the furnace body, and a corrosive gas accumulates upward, an erosion phenomenon here is not significant.

Please referring to FIG. 1, in some embodiments, a lower end of the upper lining 2 may be connected to an upper end surface of the insulating lining 3, and an upper end of the lower lining 4 may be connected to a lower end surface of the insulating lining 3.

In some embodiments, inner diameters of the upper lining 2, the insulating lining 3 and the lower lining 4 may all be identical, and in such way, it is beneficial for extracting out exhaust gas generated in the furnace.

In some embodiments, the graphitization furnace may include at least two supporting rods 7. One end of each of the supporting rods 7 may be disposed outside the graphitization furnace. The other end of each of the supporting rods 7 may be disposed inside the graphitization furnace and may be connected to the negative electrode 6. The number of the supporting rods 7 may be two or multiple. A plurality of supporting rods 7 may be disposed radially around a central axis of the graphitization furnace. The supporting rods 7 may be made of the refractory material and configured to support the negative electrode 6.

In some other embodiments, the other end of each supporting rod 7 is provided with a groove, and an outer periphery of the negative electrode 6 is embedded in the groove of each supporting rod 7.

In some embodiments, referring to FIG. 2 and FIG. 3, the upper lining 2 may include a plurality of refractory layers. An inner side surface of the upper lining 2 may include a plurality of grid-like refractory layers, and the refractory layers located on the same circumference may include a plurality of first refractory bricks 201 and second refractory bricks 202 disposed at an interval. The refractory layers located on the same generatrix may include a plurality of first refractory bricks 201 and second refractory bricks 202 disposed at an interval; and the upper lining 2 may include at least one refractory layer along a radial direction. A refractoriness under load of the first refractory brick is ≥3200° C., and an oxidation temperature of the second refractory brick is higher than the oxidation temperature of the first refractory brick.

In some other embodiments, referring to FIG. 2 and FIG. 3, the upper lining 2 may include one or more refractory layer(s) disposed and stacked in sequence in the radial direction, and extended in a circumferential direction and/or in a direction of the generatrix. At least one of the above-mentioned one or more refractory layer(s) may include a plurality of first refractory bricks 201 and second refractory bricks 202 disposed at an interval. The inner side surface of the upper lining 2 may include at least one refractory layer, and the at least one refractory layer of the inner side surface of the upper lining 2 may include a plurality of first refractory bricks 201 and second refractory bricks 202 disposed at an interval.

In some other embodiments, one or more refractory layer(s) disposed and stacked in the radial direction of the upper lining 2 include: the first refractory bricks 201 and the second refractory bricks 202 disposed alternately and in sequence in the radial direction; or the second refractory bricks 202 and the first refractory bricks 201 disposed alternately in sequence in the radial direction. The refractoriness under load of the first refractory brick is greater than or equal to 3200° C., and the oxidation temperature of the second refractory brick is higher than the oxidation temperature of the first refractory brick

In some embodiments, the refractory materials for masonry of the graphitization furnaces are generally divided into two types. One type of refractory materials has good corrosion resistance but poor oxidation resistance; and the other type of refractory materials has good oxidation resistance but poor corrosion resistance and is easy to be gasified. In the graphitization furnaces, during the graphitization process of the raw ingredients, a corrosive hydrogen fluoride gas will be produced, while a carbon used as the raw ingredients contains air. Therefore, the hydrogen fluoride gas will undergo chemical reactions with the lining to cause the lining to be corroded; oxygen in air will undergo an oxidation reaction with the lining, thereby an ablation reaction is caused and ash content is formed. At the same time, during the graphitization process, a temperature in a high-temperature zone within the graphitization furnace is as high as 2400° C., thus the lining easily gasified will be caused to undergo a gasification reaction, and gas formed will be extracted away. Therefore, if the lining is built by the refractory materials with good corrosion resistance but poor oxidation resistance, the lining will be oxidized by the oxygen existing in the graphitization process, thereby the ablation reaction is caused and the ash contents is formed, resulting in a loss of the lining and a service life of the lining of the graphitization furnace is affected. If the lining is built by the refractory materials with good oxidation resistance but poor corrosion resistance and easy to be gasified, it will be eroded by the corrosive hydrogen fluoride gas generated during the graphitization process, and the service life of the graphitization furnace will be affected.

The second refractory brick 202 with good oxidation resistance is built around the first refractory brick 201 with good corrosion resistance. Thus, when an atmosphere in the high-temperature zone within the graphitization furnace is dominated by corrosive hydrogen fluoride gas, a small amount of oxygen will undergo an oxidation ablation reaction with the first refractory bricks 201 with corrosion resistance; the hydrogen fluoride undergoes a chemical corrosion reaction with a fire-facing surface of the second refractory brick 202 to cause a concave 203 to be formed on the fire-facing surface of the second refractory brick 20, and side walls of the concave 203 are the first refractory bricks 201 with corrosion resistance. The concave 203, under a negative pressure and a blocking effect of the side wall of the concave 203, causes a large amount of hydrogen fluoride gas to be extracted away, and only a very small amount of hydrogen fluoride gas enter into the concave 203 to undergo the chemical corrosion reaction with the second refractory brick 202 at a bottom of the concave.

When the atmosphere in the high-temperature region within the graphitization furnaces is dominated by the oxygen, the first refractory bricks 201 undergo the oxidation ablation reaction with the oxygen, and thus concaves 203 are formed. Similarly, an upper side wall, a lower side wall, a left side wall, and a right side wall of the concave 203 each are the second refractory bricks 202 with oxidation resistance. The concave 203, under a negative pressure and a blocking effect of the side wall of the concave 203, causes a large amount of oxygen to be extracted away, and only a small amount of oxygen enter into the concave 203 to undergo the oxidation ablation reaction and a high-temperature gasification reaction with the first refractory brick 201 at the bottom of the concave. A small amount of hydrogen fluoride gas undergoes the chemical corrosion reaction with the second refractory brick 202.

That is to say, a chemical corrosion rate of the second refractory brick 202 disposed on center can be delayed by the first refractory bricks 201 disposed around the second refractory brick 202. An oxidation ablation speed of the first refractory brick 201 disposed on the center can be delayed by the second refractory bricks 202 disposed around the first refractory brick 201. In this way, a speed of the thickness reduction of the lining can be delayed, thereby the service life of the lining in the high-temperature zone can be improved.

Both the first refractory bricks 201 and the second refractory bricks 202 mentioned above may be regarded as one brick, or may be regarded as one brick built by a plurality of refractory bricks. A dimension of the first refractory brick 201 and the second refractory brick 202 may be flexibly selected according to a processing dimension. For example, the dimension of the first refractory brick 201 may be 50×50×20 mm, and the surface corresponding to the dimension of 50×20 mm is the fire-facing surface. When the processing dimension of the refractory bricks may be 50×50×10 mm, two refractory bricks may be combined into one first refractory brick 201 with the dimension of 50×50×20 mm. The second refractory brick 202 can be formed in the same way, which will not be repeated here.

The first refractory brick 201 has an ablation resistance, and the refractoriness under load of the first refractory brick is ≥3200° C.

The oxidation temperature of the second refractory brick 202 is higher than the oxidation temperature of the first refractory brick 201, therefore the second refractory brick 202 has better oxidation resistance than the first refractory brick 201.

In some embodiments, the dimension of the fire-facing surfaces of the first refractory brick 201 and the second refractory brick 202 may both be 100 mm˜500 mm×100 mm˜500 mm.

The fire-facing surface refers to the surface through which the refractory brick is in contact with the atmosphere in the graphitization furnace. If the dimension of the fire-facing surface of the first refractory brick 201 is larger, correspondingly the concave 203 produced by an oxidation corrosion is larger. Under the condition that the atmosphere within the furnace is dominated by oxidation, the oxygen is likely to contact the fire-facing surface within the concave 203, thus the effect of delaying an oxidizing action will become worse. However, if the dimension of the fire-facing surface of the first refractory brick 201 is too small, a masonry time will be prolonged. Similarly, the dimension of the fire-facing surface of the second refractory brick 202 is larger, and the concaves 203 formed by the chemical corrosion reaction of the hydrogen fluoride are larger, and effect of delaying corrosion will also become poor; and if the dimension of the fire-facing surface of the second refractory brick 202 is too small, the masonry time will be prolonged.

In some embodiments, the dimension of the fire-facing surface of the first refractory brick 201 and the dimension of the fire-facing surface of the second refractory brick 202 may be identical, so that a dimension of a brick gap between the first refractory brick 201 and the second refractory brick 202 will be the same.

In some embodiments, the thickness of the lining in the high-temperature zone may be 50 mm˜500 mm. If the thickness of the lining in the high-temperature zone is too thick, the cost will be increased; and if the thickness of the lining in the high-temperature zone is too thin, a life of the graphitization furnace is too short and a frequency of re-laying and re-building is high. The thickness of the lining in the high-temperature zone is actually a distance between the fire-facing surfaces of the first refractory bricks 201 and the second refractory bricks 202, and surfaces of the first refractory bricks 201 and the second refractory bricks 202 opposite to the fire-facing surfaces thereof.

In some embodiments, the first refractory brick 201 may be, but not limited to, at least one of the following: blast furnace carbon bricks, graphite carbon bricks, microporous composite carbon bricks. Both the blast furnace carbon bricks and the microporous composite carbon bricks have uniform and good ablation performance, and the refractoriness under load thereof is measured by a test for refractoriness under load. The refractoriness under load, also known as a deformation temperature under load, referred to as a softening point under load, refers to a temperature at which the refractory brick deforms under a constant pressure load under the condition of heating. The refractoriness under load indicates the resistance capability of refractory bricks to high-temperature and load at the same time and represents structural strength of the refractory bricks under similar service conditions. The refractoriness under load also indicates a temperature at which the refractory bricks under constant pressure load are deformed, and the refractory bricks are softened at this temperature, resulting in obvious plastic deformation. The higher the refractoriness under load, the better the ablation resistance of the refractory brick.

Blast furnace carbon bricks are made as below: high-temperature electric calcined anthracite is used as a main raw ingredient, an additive is added to the main raw ingredient and asphalt is used as a binder, and after being shaped, it is roasted at high temperature and finish machined. The ash content of the blast furnace carbon bricks is smaller than 8%, a compressive strength is greater than 29.6 MPa, a total porosity is smaller than 23%, a bulk density is greater than 1.5 g/cm³, and a thermal conductivity is greater than 5.0 w/(m K)³, therefore an erosion rate can be reduced. The microporous composite carbon brick may adopt a high-strength graphite disclosed in the Chinese patent publication no. CN104477902A.

In some embodiments, the second refractory brick 202 may be, but not limited to, at least one of the following: high alumina bricks, mullite bricks, silica bricks, corundum bricks, zirconia bricks, and silicon carbide bricks.

The oxidation temperature of the second refractory brick refers to a temperature at which the second refractory brick starts to be oxidized in an oxygen environment. Generally speaking, for carbon-containing refractory bricks, such as the above-mentioned silicon carbide bricks, an oxidation will occur; for the high alumina bricks, the mullite bricks, the silica bricks, the corundum bricks, and the zirconia bricks, the oxidation will not occur during the use process since carbon is not contained. Therefore, an oxidation temperature of the high alumina bricks, the mullite bricks, the silica bricks, the corundum bricks, and the zirconia bricks can be considered to be infinite.

A mass fraction of Al₂O₃ in the main components of high aluminum brick is higher than 90%, and the high aluminum bricks are formed and calcined from bauxite or other raw ingredients with high alumina content; and a refractoriness of the high alumina bricks is above 1770° C., and a thermal stability thereof is high.

The mullite bricks are made by taking a high-alumina refractory material with mullite as a main crystal phase and with a content of the alumina between 65%˜75%, and using a high-alumina bauxite clinker as the main raw ingredient, adding clay or raw bauxite as the binder, and then shaping and firing to form the Mullite bricks. The refractoriness of the mullite brick is up to over 1790° C. The refractoriness of the mullite brick is high. An initial softening temperature of the refractoriness under load of the mullite brick is 1600° C.˜1700° C., and a normal-temperature compressive strength of the mullite brick is 70 MPa˜260 MPa. A thermal shock resistance of the mullite brick is good. There are two types of the mullite brick, i.e. sintered mullite brick and electric smelted mullite brick.

The silica brick is of an acid refractory material with good resistance to acid slag erosion. The refractoriness under load of the silica brick is as high as 1640° C.˜1670° C., and its volume is relatively stable under high temperature for long-term use. In the silica brick, a silica content is above 94%, and the initial softening temperature of the refractoriness under load is 1620° C.˜1670° C. The silica brick can be used at high temperature for a long time without deformation. The silica brick is made by using a natural dinas as the raw ingredient plus an appropriate amount of mineralizer, and slowly firing at 1350° C.˜1430° C. in a reducing atmosphere. There is a total volume expansion of 1.5%˜2.2% when the silica brick is heated to 1450° C., and this residual expansion of the silica brick will make joints between the silica bricks to be closed and ensure good air tightness and the structural strength of the masonry.

The corundum brick refers to the refractory product with an alumina content greater than 90% and corundum as the main crystal phase. The normal-temperature compressive strength of the corundum brick exceeds 340 MPa, and the initial softening temperature of the refractoriness under load is greater than 1700° C. A chemical stability and the oxidation resistance of the corundum brick are better.

The zirconia brick is a heat-insulating and refractory product made of zirconia hollow spheres as the main raw ingredient. The main crystal phase of the zirconia brick is cubic zirconia, which accounts for 70% to 80% of a mineral phase composition. The refractoriness of the zirconia brick is greater than 2400° C. The apparent porosity of the zirconia brick is 55%˜60%, and a thermal conductivity of the zirconia brick is 0.23 w/(m·K) to 0.35 w/(m·K).

The silicon carbide brick is the refractory material made of SiC as the main raw ingredient, which is relatively stable against acid slag. A SiC content of the silicon carbide brick is 72%˜99%. According to different bonding phases, the silicon carbide bricks may be divided into SiC products which are clay bonding, Si₃N₄ bonding, Sialon bonding, β-SiC bonding, Si₂ON₂ bonding and recrystallization and so on, and with good oxidation resistance.

The graphitization furnace provided in the embodiments of the present disclosure has at least the following advantages:

1. There is the insulating lining disposed between the positive electrode and the negative electrode of the graphitization furnace, thus the direction of the current can be effectively guided, an energy can be concentrated, the formation of artificial electric field segments can be promoted, and a temperature and product quality of the graphitization furnace can be improved by the insulating lining. Moreover, safety accidents due to the short circuit between the positive electrode and the negative electrode during operation can be effectively avoided.

2. The upper lining in a grid interleaving type is made of the first refractory brick with oxidation resistance and the second refractory brick with oxidation resistance, thus the erosion of the atmosphere in the furnace to the lining can be effectively delayed, thereby the frequency of re-laying and re-building of the lining in the high-temperature zone of the graphitization furnace can be reduced and the service life of the lining of the graphitization furnace can be improved.

While preferred embodiments of the present application have been described, additional changes and modifications to these embodiments can be made by those of ordinary skill in the art once the basic inventive concept is appreciated. Therefore, the appended claims are intended to be construed to cover the preferred embodiments and all changes and modifications which fall within the scope sought for by the present application.

Those skilled in the art can make various changes and modifications to the present application without departing from the spirit and scope of the application. In this way, if these modifications and variations of the present application fall within the scope of the claims of the present application and their equivalent technologies, the present application is also intended to include these modifications and variations.

What is claimed is:

1. A graphitization furnace, comprising:
a furnace body;
an upper lining, an insulating lining, and a lower lining, the upper lining, the insulating lining, and the lower lining being all disposed and attached to an inner wall of the furnace body, the upper lining, the insulating lining, and the lower lining sequentially abutting against one another along a direction from top to bottom, and the upper lining, the insulating lining, and the lower lining being all provided with first through holes with a common axis; and
a positive electrode and a negative electrode, the positive electrode being disposed vertically, a lower end of the positive electrode being disposed within the upper lining, the negative electrode being disposed horizontally, a middle part of the negative electrode being provided with a second through hole for passing raw ingredients, the second through hole of the negative electrode being coaxially disposed with the first through holes, and the negative electrode being disposed inside the lower lining.

2. The graphitization furnace according to claim 1, wherein a vertical thickness of the insulating lining is 30 mm˜ 200 mm.

3. The graphitization furnace according to claim 1, wherein the insulating lining is cast from a refractory material, and the refractory material is any one selected from the group consisting of: high alumina bricks, zirconia bricks, corundum bricks and clay bricks.

4. The graphitization furnace according to claim 1, wherein inner diameters of the upper lining, the insulating lining and the lower lining are identical.

5. The graphitization furnace according to claim 1, further comprising at least two supporting rods, one end of each of the supporting rods being disposed outside the graphitization furnace, and the other end of each of the supporting rods being disposed inside the graphitization furnace and connected to the negative electrode.

6. The graphitization furnace according to claim 5, wherein the other end of each of the supporting rods is provided with a groove, and an outer periphery of the negative electrode is embedded in the groove of each of the supporting rods.

7. The graphitization furnace according to claim 1, wherein:
an inner side surface of the upper lining comprises one or more refractory layer(s) disposed in sequence in a radial direction, and extended in a circumferential direction and/or in a direction of a generatrix, and at least one refractory layer of the one or more refractory layer(s) comprises a plurality of first refractory bricks and second refractory bricks disposed at an interval;
a refractoriness under load of the first refractory bricks is ≥3200° C., and an oxidation temperature of the second refractory bricks is higher than the oxidation temperature of the first refractory bricks.

8. The graphitization furnace according to claim 7, wherein, dimensions of fire-facing surfaces of the first refractory bricks and the second refractory bricks are both 100 mm˜500 mm×100 mm˜500 mm.

9. The graphitization furnace according to claim 7, wherein the first refractory bricks are at least one selected from the group consisting of: blast furnace carbon bricks, graphite carbon bricks and microporous composite carbon bricks.

10. The graphitization furnace according to claim 7, wherein the second refractory bricks are at least one selected from the group consisting of: high alumina bricks, mullite bricks, silica bricks, corundum bricks, zirconia bricks, and silicon carbide bricks.

11. The graphitization furnace according to claim 2, wherein inner diameters of the upper lining, the insulating lining and the lower lining are identical.

12. The graphitization furnace according to claim 3, wherein inner diameters of the upper lining, the insulating lining and the lower lining are identical.

13. The graphitization furnace according to claim 2, further comprising at least two supporting rods, one end of each of the supporting rods being disposed outside the graphitization furnace, and the other end of each of the supporting rods being disposed inside the graphitization furnace and connected to the negative electrode.

14. The graphitization furnace according to claim 3, further comprising at least two supporting rods, one end of each of the supporting rods being disposed outside the graphitization furnace, and the other end of each of the supporting rods being disposed inside the graphitization furnace and connected to the negative electrode.

15. The graphitization furnace according to claim 4, further comprising at least two supporting rods, one end of each of the supporting rods being disposed outside the graphitization furnace, and the other end of each of the supporting rods being disposed inside the graphitization furnace and connected to the negative electrode.
